(19) United States
(12) Patent Application Publication
(10) Pub. No.: US 2022/0154058 A1
(43) Pub. Date: May 19, 2022

(54) MATTRESS ASSEMBLIES AND COMPONENTS INCLUDING PHASE CHANGE

(71) Applicants: Dreamwell, Ltd., Doraville, GA (US); Georgia Tech Research Corporation, Atlanta, GA (US)

(72) Inventors: Yun-Ho Ahn, Seoul (KR); Sheri McGuire, Duluth, GA (US); Ryan P. Lively, Atlanta, GA (US); Stephen J.A. DeWitt, Haverhill, MA (US)

(21) Appl. No.: 17/516,115

(22) Filed: Nov. 1, 2021

Related U.S. Application Data
(60) Provisional application No. 63/114,907, filed on Nov. 17, 2020.

(51) Int. Cl. C09K 5/06; C08L 1/02; C08L 1/12; C08L 81/06; D01D 5/06; D04H 3/015; D04H 3/009; D04H 3/013; D01F 2/30; D01F 6/66; A47G 9/02

(52) U.S. Cl. CPC C09K 5/063; A47C 27/002; C08L 1/12; C08L 81/06; D01D 5/06; D04H 3/015; D04H 3/009; D04H 3/013; D01F 2/30; D01F 6/665; A47G 9/0215; C08L 2205/20; C08L 2203/12; D10B 2401/04; A47G 9/0238; A47G 9/0253; A47G 9/0223; C08L 1/02

(57) ABSTRACT

Fibers, fabrics, mattresses and processes of making the fibers generally include a microencapsulated phase change material; and a polymer, wherein the microencapsulated phase change material is greater than 50 percent by weight of the fiber. The process for making the fibers is a dry jet/wet spinning process free of sonication.

### CROSS REFERENCE TO RELATED APPLICATIONS

The present application claims the benefit of U.S. Provisional Application No. 63/114,907 filed on Nov. 17, 2021, incorporated herein by reference in its entirety.

### BACKGROUND

The present disclosure generally relates to mattress assemblies and components of the assemblies including phase change materials.

Some heat absorbing materials can include a phase change, which is a term used to describe a reversible process in which a solid turns into a liquid or a gas. The process of a phase change from a solid to a liquid or gas requires energy to be absorbed by the solid. When a phase change material (“PCM”) liquefies, energy is absorbed from the immediate environment as it changes from the solid to the liquid. In contrast to a sensible heat storage material, which absorbs and releases energy essentially uniformly over a broad temperature range, a phase change material absorbs and releases a large quantity of energy in the vicinity of its melting/freezing point. Therefore, a PCM that melts below body temperature would feel cool as it absorbs heat, for example, from a body. Phase change materials, therefore, include materials that liquefy (melt) to absorb heat and solidify (freeze) to release heat. The melting and freezing of the material typically take place over a narrow temperature range.

PCMs can play a critical role in providing one of the efficient ways of storing thermal energy with a latent heat-based high storage capacity. The transfer of thermal energy can be driven by absorbing or releasing a latent heat with the phase transition of PCM from solid to liquid or liquid to solid. Some paraffins or salt hydrates having a high latent heat per unit volume can be utilized as a PCM. Recently, PCMs have been ‘microencapsulated’ to provide sufficient heat transfer area per unit volume, prevent a loss of material during its repetitive phase change, and protect PCM's reactivity from the surrounding environment. Microencapsulated PCM (μPCM) are typically composed of a PCM core and a polymer shell, and its diameter (0.5-1000 μm) and size distribution generally depend on the polymer shell fabrication process (e.g., in-situ polymerization, interfacial polymerization, or the like). μPCMs have been widely used in various applications such as the textile industry, building materials, photovoltaic systems, and mobile devices for thermal modulation. The thermostatic fabric composed of polyester and microencapsulated octadecane was a promising candidate due to their thermal storing/releasing properties and laundering durability/stability. When μPCMs are incorporated into the conventional building materials, these materials can contribute to saving energy via smoother control over the temperature inside the building.

### BRIEF SUMMARY

Disclosed herein are fibers, fabrics, mattresses and processes of making the fibers generally include microencapsulated phase change material; and a polymer, wherein the microencapsulated phase change material is greater than 50 percent by weight of the fiber. The process for making the fibers is a dry jet/wet spinning process free of sonication.

In one or more embodiments, a microencapsulated phase change material fiber composite includes microencapsulated phase change material; and a polymer, wherein the microencapsulated phase change material is greater than 50 percent by weight of the fiber.

In one or more embodiments, a fabric includes a plurality of fibers, wherein the fibers comprise microencapsulated phase change material; and a polymer, wherein the microencapsulated phase change material is greater than 50 percent by weight of the fiber.

In one or more embodiments, a mattress includes at least one fabric layer in contact and/or in proximity to an end user, wherein the at least one fabric layer comprises a plurality of fibers, wherein the fibers comprise microencapsulated phase change material; and a polymer, wherein the microencapsulated phase change material is greater than 50 percent by weight of the fiber.

In one or more embodiments, a dry jet/wet spinning process of manufacturing a fiber includes providing a spin dope, wherein the spin dope comprises microencapsulated phase change materials, a polymer, a water soluble surfactant, and a solvent, wherein the polymer is soluble in the solvent and the microencapsulated phase change material is uniformly dispersed in the spin dope without sonication; pumping the spin dope into a multi-hole spinneret to extrude filaments therefrom; feeding the filaments into a coagulation bath system to form microencapsulated phase change material fiber composites and removing residual solvent and water soluble surfactant, wherein the spinneret is spaced apart from the coagulation bath by an air gap; and drawing the fiber, wherein the microencapsulated phase change material is greater than 50 percent by weight of the fiber.

The disclosure may be understood more readily by reference to the following detailed description of the various features of the disclosure and the examples included therein.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 schematically illustrates a dry jet/wet spinning apparatus and process flow for fabricating microencapsulated phase change material fiber composites in accordance with one or more embodiments of the present invention;

FIG. 2 depicts scanning electron micrographs illustrating cross sections of various microencapsulated phase change material fiber composites showing the distribution of microencapsulated phase change material within the fibers in accordance with one or more embodiments of the present invention;

FIG. 3 depicts scanning electron micrographs illustrating cross sections of various microencapsulated phase change material fiber composites subsequent to exposure to different treatments in accordance with one or more embodiments of the present invention;

FIG. 4 graphically illustrates differential scanning calorimetry plots depicting reversible heat flow curves for various microencapsulated phase change material having different melting points in accordance with one or more embodiments of the present invention;

FIG. 5 graphically illustrates differential scanning calorimetry plots depicting reversible heat flow curves for various blended microencapsulated phase change material fiber composites in accordance with one or more embodiments of the present invention;

FIG. 6 graphically illustrates take up rates as a function of diameter for microencapsulated phase change material cellulose fiber composites having different initial loadings of the phase change material, the fraction of the microencapsulated phase change material remaining relative to the initial spin dope formulation, and the latent heat of melting/freezing of a microencapsulated phase change material cellulose fiber composite after multiple heating cooling cycles in accordance with one or more embodiments of the present invention;

FIG. 7 graphically and pictorially illustrates mechanical properties of microencapsulated phase change material cellulose fiber composites with different microencapsulated phase change material loadings in accordance with one or more embodiments of the present invention; and

FIG. 8 graphically illustrates stress versus strain curves as a function of microencapsulated phase change material loading in accordance with one or more embodiments of the present invention.

The diagrams depicted herein are illustrative. There can be many variations to the diagram or the operations described therein without departing from the spirit of the invention. All of these variations are considered a part of the specification.

### DETAILED DESCRIPTION

Disclosed herein are mattress assemblies and mattress components including a microencapsulated phase change material (μPCM)-fiber composite and fabrication thereof. Applicants have discovered that a dry jet/wet spinning process can be used to form μPCM fibers, wherein one or more solid μPCMs can be added to a solvent containing a polymer to form a spin dope, which is then utilized to form μPCM fibers.

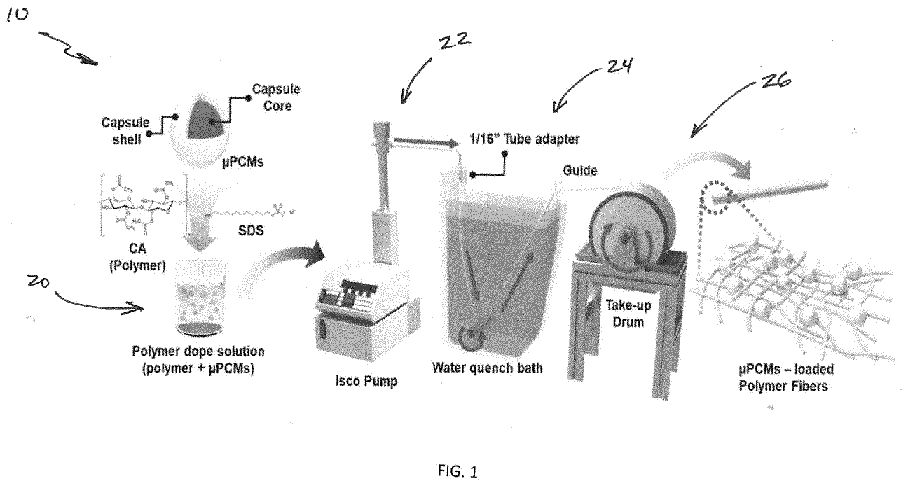

FIG. 1 presents schematically an exemplary dry jet/wet spinning apparatus and process flow 10 according to the present disclosure. Spinning dope according to the present disclosure is formed in a vessel 20 by first dispersing μPCM in a solvent and an optional water-soluble surfactant followed by adding a polymer, which is then mixed until the polymer is dissolved. Advantageously, the optional water-soluble surfactant can eliminate the need for sonication to uniformly disperse the μPCM within the spin dope. The spin dope transferred to a pump 22, which is then pumped through a device referred to as a spinneret, which is a multi-hole spinning head. The spinning solution passes through holes in the spinneret to form filaments. These filaments pass through an air gap to a coagulation system 24 and then to a drawing system 26. The filaments are cooled in the air gap and convert from a solution to a gel. The resulting gel can be oriented by stretching during this stage as the polymer is coagulated or after removal from the spin bath. The long fibers can then be fed to a coagulation system to remove residual solvent and any impurities. The coagulation system 24 can include, for example, one or more baths, which facilitates removal of any solvent, water soluble surfactant, and the like. The baths can include water, a polar solvent or mixtures thereof and are generally configured based on the solvent used to form the spin dope. The temperature of each bath is maintained at about room temperature to decrease the rate of diffusion of the polar spinning solvent. The drawing system is not intended to be limited and can include a take up drum, for example. In one or more embodiments, the fibers can pass through a drier. The resulting fibers are loaded with μPCM, wherein the loading of the μPCM can be in excess of 50% by weight based on a total weight of the μPCM fibers in one or more embodiments. In other embodiments, the loading of the μPCM is greater than 50% by weight, and in still other embodiments, the of the μPCM can be in greater than 70% by weight.

The resulting μPCM fibers can be used to form fabrics, which can be used in the manufacture of mattress assemblies. For example, a non-woven fabric can be formed that includes the μPCM fibers to form a quilt layer, a topper layer, a bedding sheet, a pillow cover, or the like, wherein the phase change material can provide a cooling effect via heat absorption to an end user of the mattress assembly. Generally, the fabric formed from the μPCM fibers is provided in a fabric layer that is proximate to and/or defines the sleeping surface and/or contacts an end user during use, e.g., a bed sheet, comforter or the like.

Suitable polymers include, without limitation, polyesters, polyolefins such as a polypropylene and polyethylene, cellulose, cellulose acetate, rayon, nylon, polyether sulfone, elastomeric fibers and the like, and mixtures thereof.

The resulting μPCM fibers may have varying diameter and denier, be hollow or solid, or may be crimped. Blending different types of fibers may further contribute to resiliency of the fabric layer.

The phase change material is not intended to be limited to any particular phase change material and could be a phase change material that does not undergo a phase change during use by an end user of the mattress. For example, the phase change transition temperature of the phase change material can be relatively high so that a phase change does not occur upon interaction with a user of the phase change material but can still absorb a considerable amount of heat.

Phase change materials that can be incorporated in the fibers in accordance with various embodiments of the disclosure include a variety of organic and inorganic substances including paraffins; bio-phase change materials derived from acids, alcohols, amines, esters, and the like; salt hydrates; and the like. The particular phase change material or mixtures thereof are not intended to be limited.

Exemplary phase change materials include hydrocarbons (e.g., straight chain alkanes or paraffinic hydrocarbons, branched-chain alkanes, unsaturated hydrocarbons, halogenated hydrocarbons, and alicyclic hydrocarbons), bio-phase change materials derived from acids, alcohols, amines, esters, and the like, hydrated salts (e.g., calcium chloride hexahydrate, calcium bromide hexahydrate, magnesium nitrate hexahydrate, lithium nitrate trihydrate, potassium fluoride tetrahydrate, ammonium alum, magnesium chloride hexahydrate, sodium carbonate decahydrate, disodium phosphate dodecahydrate, sodium sulfate decahydrate, and sodium acetate trihydrate), waxes, oils such as coconut oil, rice oil and the like, fatty acids, fatty acid esters, dibasic acids, dibasic esters, 1-halides, primary alcohols, aromatic compounds, clathrates, semi-clathrates, gas clathrates, anhydrides (e.g., stearic anhydride), ethylene carbonate, polyhydric alcohols (e.g., 2,2-dimethyl-1,3-propanediol, 2-hydroxymethyl-2-methyl-1,3-propanediol, ethylene glycol, polyethylene glycol, pentaerythritol, dipentaerythritol, pentaglycerine, tetramethylol ethane, neopentyl glycol, tetramethylol propane, 2-amino-2-methyl-1,3-propanediol, monoaminopentaerythritol, diaminopentaerythritol, and tris(hydroxymethyl)acetic acid), polymers (e.g., polyethylene, polyethylene glycol, polyethylene oxide, polypropylene, polypropylene glycol, polytetramethylene glycol, polypropylene malonate, polyneopentyl glycol sebacate, polypentane glutarate, polyvinyl myristate, polyvinyl stearate, polyvinyl laurate, polyhexadecyl methacrylate, polyoctadecyl methacrylate, polyesters produced by polycondensation of glycols (or their derivatives) with diacids (or their derivatives), and copolymers, such as polyacrylate or poly(meth)acrylate with alkyl hydrocarbon side chain or with polyethylene glycol side chain and copolymers comprising polyethylene, polyethylene glycol, polyethylene oxide, polypropylene, polypropylene glycol, or polytetramethylene glycol), metals, and mixtures thereof.

The selection of the phase change material will typically be dependent upon a desired transition temperature for manufacture or for use thereof in a mattress assembly. For example, a phase change material having a transition temperature near room temperature may be desirable for mattress applications to maintain a comfortable temperature for a user. Additionally, suitable phase change materials are those that can be microencapsulated. Any of a variety of processes known in the art may be used to microencapsulate PCMs in accordance with the present disclosure. One of the most typical methods which may be used to microencapsulate a, PCM is to disperse droplets of the molten PCM in an aqueous solution and to form walls around the droplets using techniques such as coacervation, interfacial polymerization and in situ polymerization all of which are well known in the art. For example, the methods are well known in the an to form gelatin capsules by coacervation, polyurethane or polyurea capsules by interfacial polymerization, and urea-formaldehyde, urea-resorcinol-formaldehyde, and melamine formaldehyde capsules by in situ polymerization. In accordance with particular embodiments of the present invention, The wall material for encapsulating PCMs is not intended to be limited so long as it is chemically stable within the dry jet/wet spinning process for forming the μPCM fibers.

The microcapsules will typically have a relatively high payload of phase change material, typically at leak 70% by weight based on a total weight, more typically at least 80% by weight, and in accordance with some embodiments, the microcapsules may contain more than 90% phase change material.

A phase change material according to some embodiments can be selected to have a transition temperature ranging from about 22° to about 40° C., although lesser or greater transition temperatures can be used. In one or more other embodiments, the phase change material can have a transition temperature ranging from about 26° to about 30° C. With regard to paraffin phase change materials, the number of carbon atoms of a paraffinic hydrocarbon typically correlates with its melting point. For example, n-octacosane, which contains twenty-eight straight chain carbon atoms per molecule, has a melting point of 61.4° C. whereas n-tridecane, which contains thirteen straight chain carbon atoms per molecule, has a melting point of −5.5° C. According to an embodiment of the invention, n-octadecane, which contains eighteen straight chain carbon atoms per molecule and has a melting point of 28.2° C., is particularly desirable for mattress applications.

Other useful phase change materials include polymeric phase change materials having transition temperatures from about 22° to about 40° C. A polymeric phase change material may comprise a polymer (or mixture of polymers) having a variety of chain structures that include one or more types of monomer units. In particular, polymeric phase change materials may include linear polymers, branched polymers (e.g., star branched polymers, comb branched polymers, or dendritic branched polymers), or mixtures thereof. A polymeric phase change material may comprise a homopolymer, a copolymer (e.g., terpolymer, statistical copolymer, random copolymer, alternating copolymer, periodic copolymer, block copolymer, radial copolymer, or graft copolymer), or a mixture thereof. As one of ordinary skill in the art will understand, the reactivity and functionality of a polymer may be altered by addition of a functional group such as, for example, amine, amide, carboxyl, hydroxyl, ester, ether, epoxide, anhydride, isocyanate, silane, ketone, and aldehyde. Also, a polymer comprising a polymeric phase change material may be capable of crosslinking, entanglement, or hydrogen bonding in order to increase its toughness or its resistance to heat, moisture, or chemicals.

According to some embodiments of the invention, a polymeric phase change material may be desirable as a result of having a higher molecular weight, larger molecular size, or higher viscosity relative to non-polymeric phase change materials (e.g., paraffinic hydrocarbons). In addition to providing thermal regulating properties, a polymeric phase change material may provide improved mechanical properties (e.g., ductility, tensile strength, and hardness).

For example, polyethylene glycols may be used as the phase change material in some embodiments of the invention. The number average molecular weight of a polyethylene glycol typically correlates with its melting point. For instance, a polyethylene glycol having a number average molecular weight range of 570 to 630 (e.g., Carbowax 600) will have a melting point of 20° to 25° C., making it desirable for mattress applications. Further desirable phase change materials include polyesters having a melting point in the range of 22° to 40° C. that may be formed, for example, by polycondensation of glycols (or their derivatives) with diacids (or their derivatives).

According to some embodiments, a polymeric phase change material having a desired transition temperature may be formed by reacting a phase change material (e.g., an exemplary phase change material discussed above) with a polymer (or mixture of polymers). Thus, for example, n-octadecylic acid (i.e., stearic acid) may be reacted or esterified with polyvinyl alcohol to yield polyvinyl stearate, or dodecanoic acid (i.e., lauric acid) may be reacted or esterified with polyvinyl alcohol to yield polyvinyl laurate. Various combinations of phase change materials (e.g., phase change materials with one or more functional groups such as amine, carboxyl, hydroxyl, epoxy, silane, sulfuric, and so forth) and polymers may be reacted to yield polymeric phase change materials having desired transition temperatures.

Also, the phase change material according to one or more embodiments can have a latent heat that is at least about 40 Joules/gram (J/g), at least about 50 J/g in other embodiments, and at least about 60 J/g in still other embodiments. As used herein, the term “latent heat” can refer to an amount of heat absorbed or released by a substance (or mixture of substances) as it undergoes a transition between two states. Thermal energy can be stored or removed from a phase change material, and the phase change material typically can be effectively recharged by a source of heat or cold. By selecting an appropriate phase change material, a multi-component fiber can be designed for use in any one of numerous products.

The phase change material can include a mixture of two or more substances (e.g., two or more of the exemplary phase change materials discussed above). By selecting two or more different substances (e.g., two different paraffinic hydrocarbons) and forming a mixture thereof, a temperature stabilizing range can be adjusted over a wide range to extend the cooling effect over a longer period of time. For example, octadecane can be used as the primary phase change material to which a small amount of phase change material(s) having a lower carbon content (e.g., C₁₆, C₁₇) can be used to lower the melting point, which can make the mixture less hard at room temperature. According to some embodiments of invention, the mixture of two or more different substances may exhibit two or more distinct transition temperatures or a single modified transition temperature.

With the various combinations of paraffin or branched hydrocarbon materials having different melting points, μPCM's melting point can be designed and engineered to fulfill various industrial and commercial needs. By way of example, three types of commercial μPCMs (Nextek 18D, 24D, and 28D), having the melting points of 18° C., 24° C., and 28° C., respectively, were examined in greater detail to form various μPCMs-fibers and utilized in the examples below. It should be apparent that the present disclosure is not intended to be limited to these specific phase change materials, which are not intended to be limited.

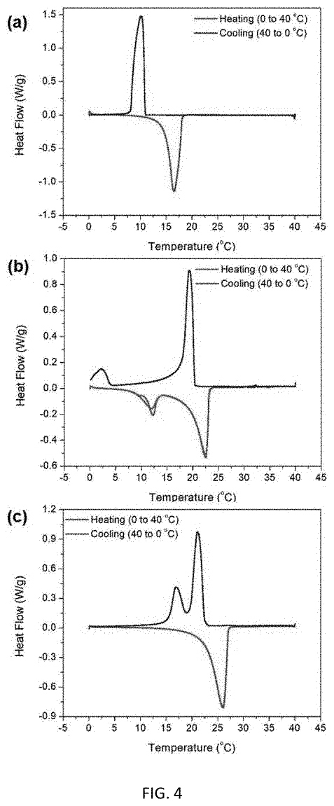

After examining the chemical stability of these μPCMs by themselves in different solvent systems, the thermal response behavior using a DSC was examined before utilizing them to make a μPCM-polymer dope as shown in FIG. 4. From the heat flow vs. temperature curve, the freezing and melting point of μPCM can be defined as the onset temperature where the phase change starts. In the case of 18D (FIG. 4(a)) and 28D (FIG. 4(c)), the heat flow curves of two repetitive heating-cooling cycles were almost identical, but there was a minor difference in the heating curves of 24D (FIG. 4(b)). The thermal behaviors confirms that the phase change phenomenon of μPCM is reversible with the same freezing/melting temperature, and advantageously there is no heat capacity loss after the phase change. The latent heats of heating or cooling, which can be obtained by the integration of the heat flow curve to time, are summarized in Table 1.

TABLE 1

| | | T_{f,peak} | | | T_{m,peak} | |
|---|---|---|---|---|---|---|
| | T_{f} [° C.] | [° C.] | ΔĤ_{f} [J/g] | Tₘ [° C.] | [° C.] | ΔĤₘ [J/g] |
| Nextek 18D | 10.87 | 10.31 | 169.44 | 15.03 | 16.57 | 168.76 |
| Nextek 24D | 20.30 | 19.34 | 127.28 | 19.37 | 22.53 | 114.82 |
| Nextek 28D | 22.42 | 21.23 | 164.22 | 22.78 | 26.02 | 161.58 |

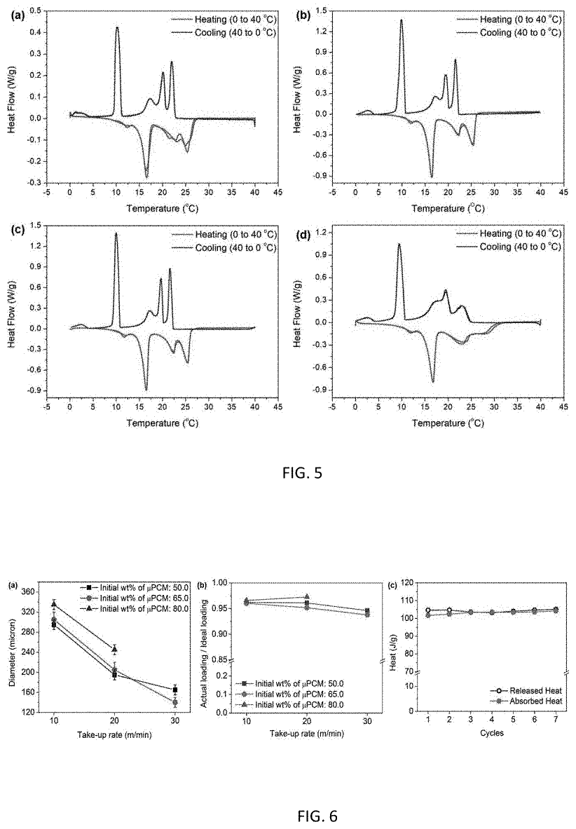

To achieve a wide range of working temperature of thermally modulated fibers, the μPCM-polymer fibers were that contained three types of μPCMs (18D, 24D, and 28D) in one fiber structure. Fibers including blended μPCMs with different melting temperatures can be used in the textile applications and provide a latent heat profile to improve comfort for users. FIG. 5(a) graphically illustrates the heating and cooling curves of (a) blended μPCM (18D, 24D, and 28D); FIG. 5(b) graphically illustrates the heating and cooling curves of blended μPCM-CA fiber, FIG. 5(c) graphically illustrates the heating and cooling curves of blended μPCM-PES fiber, and FIG. 5(d) graphically illustrates the heating and cooling curves of blended μPCM-cellulose fiber measured with the heating/cooling rate of 1° C./min. Each sample was tested for 2 heating and cooling cycles, wherein all samples showed a negligible difference between each cycle.

Referring to FIG. 5(a), although three μPCMs were mixed without any treatment, the normalized heat flow of blended μPCMs was slightly lower than those of each individual μPCMs (see FIG. 4). This is believed due to the packing density of the μPCM powders: the heat flow can be obtained differently depending on the packing/loading of the sample in the DSC sample pan.

Interestingly, when the blended μPCMs were incorporated into the porous CA and PES fiber structure (see FIGS. 5(b) and 5(c)), somewhat higher heat flow was obtained with the similar curve shape of blended μPCM powders in a bulk phase. Compared to the bulk μPCM powders that showed different thermal response behaviors in two heating cycles (see FIG. 5(a)), blended μPCMs in CA or PES fibers showed almost identical thermal response behaviors. This can be explained by the structure of CA and PES fiber: μPCMs's latent heat can be rapidly transferred from/to the environment via enhanced convection through the pores as opposed to the large, air-filled “gaps” in a loose μPCM capsule powder. Complete dispersion of μPCMs in the porous fiber makes most μPCMs exist independently and readily available. These structured μPCMs in the fiber are different from the bulk phase powder, and they can respond quickly to changes in the surrounding temperatures by releasing/absorbing and transferring the latent heat simultaneously.

Although we observed some deformed μPCMs in the μPCM-cellulose fiber (see FIGS. 3(f) and 3(g)), the μPCMs apparently still perform as a heat reservoir by exhibiting a reversible phase change consistent with the virgin μPCM capsules (see FIG. 5(d)). Thus, it can be concluded that μPCMs can be successfully incorporated into the cellulose fiber while maintaining their heat storing/releasing properties. Slightly lower heat flow compared to the μPCM-CA/PES fibers was observed as shown in FIGS. 4(b) and 4(c), but the heat transfer was still faster than the bulk phase of μPCMs. A non-porous structure of the cellulose matrix, formed by the shrinkage during a drying step, might delay the convection of latent heat, but the fiber's small characteristic length can overcome this issue relative to a loose collection of capsules. It was also observed that there were two overlapped exothermic peaks coming from the Nextek μPCMs 24D and 28D, which implies that the phase change of one capsule might affect that of another when they exist in the confined space of the shrunk cellulose fiber. From these results, the porous structure and short characteristic length of the fiber can improve the heat transfer rate; thus incorporation of μPCMs in the polymer fiber is a pathway for creating fiber-based PCM materials such as wraps, fabrics, fiber bundles, and other structures.

The loading of the μPCMs in the polymer fiber is generally greater than 50% by weight and can generally be calculated from the dope composition. If all μPCMs are assumed to be loaded in the fiber without leaching and there is no remaining solvent or additives with a sufficient solvent-exchange, washing, and drying, the loading amount of μPCMs can be calculated as follows.

$$Ideal loading of μ PCMs = \frac{weight of μ PCMs : n the dope}{weight of μPCMs + weight of the polymer in the dope} \qquad eq ( 1 )$$

The calculated ideal loading amounts of μPCMs in each fiber are listed in Table 2 below.

With the ideal loading amounts of μPCMs, the fraction of each μPCM in the ideal loading (xᵢ), and the latent heat of freezing of μPCM powders (ΔĤ_{f} for 18D, 24D, and 28D) listed in Table 2 above, ‘ideal’ latent heat of freezing of μPCM-polymer fiber (“Ideal ΔĤ_{f}”) can be calculated as follows.

$$Ideal Δ {\hat{H}}_{f} = ( Δ {\hat{H}}_{f , 18 D} \cdot {x}_{18 D} + Δ {\hat{H}}_{f , 24 D} \cdot {x}_{24 D} + Δ {\hat{H}}_{f , 28 D} \cdot {x}_{28 D} ) \qquad eq ( 2 )$$

With the actual latent heat of freezing of μPCM-polymer fiber listed in Table 3 below (determined by the integration of the heat flow curve measured by DSC), we can estimate the ratio of actual and ideal latent heat of freezing for the μPCM-polymer fibers

$$( Actual Δ {\hat{H}}_{f} / Ideal Δ {\hat{H}}_{f} ) .$$

This ratio can be multiplied by the ideal loading amount of μPCMs to estimate the actual loading amount of μPCMs remaining after the fiber fabrication process. The results of the above calculation for CA, PES, and cellulose fibers are listed in Table 3. While thermogravimetric analysis (TGA) is widely used to determine the loading of solid non-soluble additives within fiberous materials in the case of materials that fully thermally decompose in air at the same or near the same temperature as the polymer, it is necessary to employ other methods. DSC is desirable for phase change material because it is unlikely (and easy to confirm) that a latent heat change will occur from any species other than the PCM. From these calculations, most of the μPCMs initially loaded in the dope ultimately remain in the fiber structure (95% for CA, 96% for PES, and 98% of cellulose) implying that there is no significant loss of μPCMs or μPCM performance during the whole fiber fabrication process.

TABLE 2

| | ΔĤ_{f} [J/g] | ΔĤₘ [J/g] | Ideal ΔĤ_{f} [J/g] | $\frac{Actual Δ {\hat{H}}_{f}}{Ideal Δ {\hat{H}}_{f}}$ | Actual μPCM loading [wt %] |
|---|---|---|---|---|---|
| CA | 109.11 | 111.27 | 115.24 | 0.95 | 71.01 |
| PES | 106.10 | 106.27 | 110.03 | 0.96 | 69.04 |
| Cellulose | 110.45 | 116.81 | 112.93 | 0.98 | 71.92 |

To further characterize the μPCM-cellulose fiber, we fabricated μPCM-cellulose fibers with different dope compositions and spinning parameters as shown in Table 3 below.

TABLE 3

| Ideal μPCM loading [wt %] | Take-up rate [m/min] | ΔH̅_{f} [J/g] | ΔĤₘ [J/g] | Ideal ΔĤ_{f} [J/g] | $\frac{Actual Δ {\hat{H}}_{f}}{Ideal Δ {\hat{H}}_{f}}$ | Actual μPCM loading [wt %] | Diameter [μm] |
|---|---|---|---|---|---|---|---|
| 50.0 | 10 | 79.02 | 77.75 | 82.11 | 0.96 | 48.12 | 290-300 |
| 50.0 | 20 | 78.93 | 69.01 | 82.11 | 0.96 | 48.06 | 190-200 |
| 50.0 | 30 | 77.70 | 72.17 | 82.11 | 0.95 | 47.31 | 160-170 |
| 65.0 | 10 | 102.52 | 103.71 | 106.74 | 0.96 | 62.43 | 290-310 |
| 65.0 | 20 | 101.59 | 101.52 | 106.74 | 0.95 | 61.86 | 190-210 |
| 65.0 | 30 | 100.11 | 98.72 | 106.74 | 0.94 | 60.96 | 130-150 |
| 80.2 | 10 | 126.91 | 130.34 | 131.38 | 0.97 | 77.28 | 330-340 |
| 80.2 | 20 | 127.78 | 120.06 | 131.38 | 0.97 | 77.81 | 240-250 |

These μPCM-cellulose fibers using μPCM (Nextek 28D) were analyzed their structural and thermal properties. With the same ideal μPCM loading amount, the diameter of the μPCM-cellulose fiber decreased as the take-up rate increased as shown in FIG. 6(a). As the ideal μPCM loading increased from 50 to 80 wt %, the diameter of the dried μPCM-cellulose fiber decreased although those fibers were spun with the same core flow rate and take-up rate. Because of the large amount of μPCM in the dope, the fraction of cellulose that can shrink after the drying process becomes relatively small in the fiber resulting in a low degree of shrinking. In the case of 80 wt % μPCM dope, the fiber could not be spun with the take-up rate of 30 m/min due to the low stability of the spin line. All corresponding diameter values of each fiber are summarized in Table 3 above.

The actual μPCM loadings in the cellulose fibers spun with different ideal μPCM loadings and take-up rates were obtained based on the latent heat of freezing of μPCMs (see FIG. 5(b) and Table 3). Around 95% of the thermal storage capacity was retained in the cellulose fiber after the fabrication process, implying that the total loss of μPCM during the spinning and subsequent solvent exchange steps was less than 5%. The μPCM-CA, PES (Table 2), and cellulose fibers (Table 3) prepared via dry jet wet-quench solution spinning achieved the highest μPCM loading and the largest thermal energy storage capacity compared to previously reported thermal regulating fabrics/fibers prepared by different approaches (e.g., PCM coating, melt spinning, etc.).

The thermal response behavior of μPCM-cellulose fiber having the actual μPCM loading of 62.43 wt % was tested with 7 repetitive heating/cooling cycles. The latent heats of melting/freezing of μPCMs were found to remain almost constant, which implies that the phase change of μPCM in the cellulose fiber is reversible with no loss of materials inside the capsule. (see FIG. 6(c)).

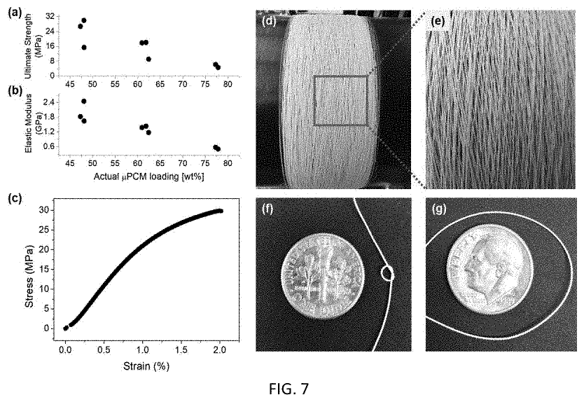

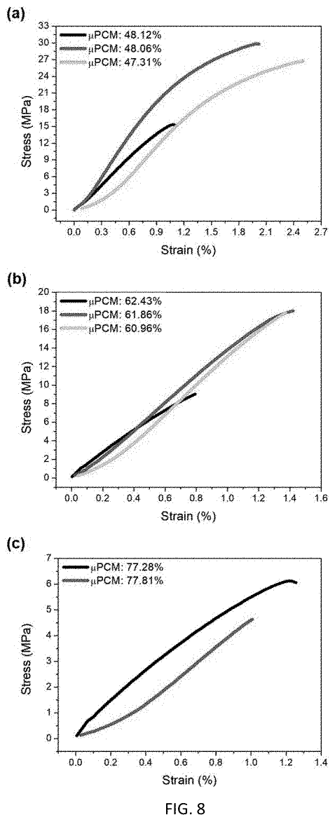

Dynamic mechanical analysis (DMA) was used to investigate the mechanical properties (ultimate strength and elastic modulus) of the μPCM-cellulose fibers with the results generally shown in FIG. 7(a-c). As the amount of μPCM loading increased from 48 wt % to ˜77 wt %, the ultimate strength of μPCM-cellulose fiber decreased from ˜30 MPa to ˜5 MPa (see FIG. 7(a)), which is corroborated by our observation of line instability in the 80 wt % dope with the take-up rate of 30 m/min. Similarly, the average elastic modulus of μPCM-cellulose fiber decreased from 2 to 0.5 GPa (see FIG. 7(b)). The fiber's elastic modulus was obtained from the slope of the stress-strain curve from 0 to 1% of strain (see FIG. 7(c) and the stress-strain curves shown in FIG. 8). The exact values of ultimate strength and elastic modulus with respect to the actual μPCM loading are listed in Table 4. Some lignocellulosic biomass composite fibers were solution-processed under different dissolution conditions, without PCM, and their mechanical properties were related to the cellulose contents or processing temperature: the ultimate stress is proportional to the cellulose contents. The ultimate stress of ‘Pine’ fiber (55.9% cellulose+32.4% lignin, dissolved at 175° C.) was 49 MPa, and that of “Bagasse’ fiber (63.6% cellulose+25.3% lignin, dissolved at 185° C.)) was 125 MPa. Compared to the ultimate strength of pure cellulose fiber (220 MPa) or that of some thermoplastic polymers (polypropylene: 26-41.4 MPa, high-density polyethylene: 14.5-38 MPa, polystyrene: 25-69 MPa), those of μPCM-cellulose fibers are smaller (less than 30 MPa), because of the passive solid fillers, i.e., μPCMs. Despite the lower ultimate strength, only 20 wt % of cellulose within the fiber was needed to maintain the fiber structure and general ability to handle and manipulate the fibers. This high loading of μPCM is particularly useful for energy storage applications and is the highest PCM loading in a fiber material to date. Importantly, μPCM-cellulose fibers can be fabricated into different structures or geometry depending on the end application. As a simple proof-of-concept, a pseudo-non-woven fabric composed of μPCM-cellulose fiber was prepared by using our spinning system (FIGS. 7(d) and 7(e)). Moreover, despite its low elastic modulus, we can make a knot (FIG. 7(f) with the highly loaded μPCM-cellulose fibers (77 wt %) (see FIG. 7(e)).

TABLE 4

| Actual | | Average | | Average |
|---|---|---|---|---|
| μPCM | Elastic | Elastic | Ultimate | Ultimate |
| loading | Modulus | Modulus | Strength | Strength |
| [wt %] | [GPa] | [GPa] | [MPa] | [MPa] |
| 0 | — | — | 220.00 | — |
| 48.12 | 1.64 | 1.97 ± 0.35 | 15.34 | 23.98 ± 6.24 |
| 48.06 | 2.45 | | 29.86 | |
| 47.31 | 1.82 | | 26.73 | |
| 62.43 | 1.17 | 1.32 ± 0.11 | 9.02 | 14.95 ± 4.20 |
| 61.86 | 1.43 | | 18.01 | |
| 60.96 | 1.38 | | 17.83 | |
| 77.28 | 0.57 | 0.54 ± 0.04 | 6.13 | 5.38 ± 0.75 |
| 77.81 | 0.50 | | 4.63 | |

In summary, μPCM-polymer fiber composites were designed and successfully spun with a high loading amount of different μPCMs. Three types of μPCMs with different melting/freezing temperatures were utilized and the highest loading of ˜78 wt % was confirmed by differential scanning calorimetry. We developed an energy-efficient method to prepare μPCM-dispersed polymer solutions that does not require an energy-intensive sonication step: a small amount of surfactant SDS and sequentially added polymers could maintain the dispersion phase of μPCM on the shear mixer. Compared to the initial μPCM loading in the polymer solution, more than 94% of μPCMs remain in the fiber after the entire fabrication procedure. Three types of polymer, cellulose acetate (CA), polyethersulfone (PES), and cellulose were used to make fiber-type contactors for μPCMs, and we observe that the porous structure of CA and PES fiber contributes to enhancing the heat transfer during μPCM's phase change. However, due to the volume shrinkage of cellulose fiber after being dried, the heat flow of μPCM-cellulose fiber is somewhat lower but still higher than that of bulky μPCM powders. The thermal energy storage densities of μPCM-CA, PES, and cellulose fibers were over 105 J/g. We observe a trade-off between mechanical stability and thermal energy storage capacity of the μPCM-cellulose fiber. However, because of the exceptional mechanical properties of cellulose, loadings of as low as 20 wt % for cellulose, allowing for 80 wt % to be filler maintain the fiber structure. Moreover, μPCM-cellulose fibers can be converted into a pseudo-non-woven fabric or a small knot. With good solution-processability and superior thermal energy storage capacity, we believe our findings of μPCM-polymer fibers present a promising material that can be applied across a wide range of thermal modulation and sustainable energy storage systems.

### Examples

In this example, cellulose acetate (CA, 50,000 MW, Sigma-Aldrich), polyethersulfone (PES, Veradel® 3000P, Solvay), and microcrystalline cellulose (20 μm, Sigma-Aldrich) were dried in 80° C. vacuum oven overnight and used as the polymers for the fabrication of μPCM spunbond fibers. Polyvinylpyrrolidone (PVP, 55,000 MW, Sigma-Aldrich), N-methyl-2-pyrrolidone (NMP, 99.5%, Sigma-Aldrich), lithium nitrate (LiNO₃, ReagentPlus®, Sigma-Aldrich), lithium chloride (LiCl, 99.0%, Alfa Aesar), N-methylmorpholine N-oxide (NMMO, 97.0%, Sigma-Aldrich), and sodium dodecyl sulfate (SDS, 99.0%, Sigma-Aldrich) were used without further purification. Deionized water of ultrahigh purity was supplied from an ELGA LabWater purification unit (DV35, ELGA LabWater, USA). Microencapsulated phase change materials (μPCMs, Nextek 18D, 24D, and 28D, Microtek Laboratories, Inc.) with the particle size of 15 to 30 microns were purchased and used after being dried in 80° C. vacuum oven. The melt points of Nextek 18D, 24D and 28D were 18° C., 24° C., and 28° C. respectively. In these commercially available μPCMs, mixtures of branched-chain hydrocarbons are encapsulated by the melamine formaldehyde shell, which prevents phase change materials from leaking during their phase change.

The procedure for the fabrication of μPCM-loaded polymer fibers from the dope preparation to the dry jet wet-quench spinning is illustrated in FIG. 1. First, the targeted amounts of μPCMs were dispersed in a solution consisting of solvent (NMP), non-solvent (DI water), and additive (PVP and LiNO₃ were used as a pore-former and pore-suppressor for CA and PES fiber, respectively, SDS was used as a dispersion enhancer) by shear mixing for 3 hours. The polymers (CA or PES) were slowly added and mixed at 50° C. to be dissolved in the μPCM-dispersed mixture. After 3 hours, the polymer solution with well-dispersed μPCM was transferred to the roller and rolled overnight to eliminate air bubbles.

The μPCM-added cellulose solutions were prepared in an alternate method since dissolving cellulose utilizes a relatively high temperature. The targeted amounts of μPCMs were dispersed in a solution consisting of a solvent (NMP), SDS, and additive (LiCl) by shear mixer for 1 hour. Cellulose powders were slowly added and mixed at room temperature for 1 hour. The mixture was then moved to the pre-heated oil bath (120° C.) to dissolve cellulose and stirred for 3 hours. The cellulose solution with well-dispersed μPCM was transferred to the roller and rolled overnight to eliminate air bubbles. All compositions of the μPCM-added polymer solution are summarized in Table 5.

TABLE 5

| | | CA | | | PES | | Cellulose | | |
|---|---|---|---|---|---|---|---|---|---|
| Dope | Polymer | 15.5 | 15.6 | 9.9 | 12.9 | 7.8 | 9.0 | 6.9 | 5.4 |
| Composition | NMP | 54.5 | 55.0 | 49.0 | 52.3 | 62.1 | 72.1 | 72.5 | 66.5 |
| (wt %) | H₂O | 7.4 | 7.5 | 6.6 | 0.3 | — | — | — | — |
| | Additive¹ | PVP | | | LiNO₃ | | LiCl | | |
| | | 6.2 | 6.3 | 4.0 | 1.4 | 7.8 | 9.0 | 6.9 | 5.4 |
| | SDS | 0.9 | — | 0.7 | 0.7 | 0.8 | 0.9 | 0.9 | 0.8 |
| | mPCM | 15.5 | 15.6 | 29.8 | 32.4 | 21.5 | 9.0 | 12.8 | 21.9 |
| | Ideal | 50.0 | 50.0 | 75.0 | 71.6 | 73.5 | 50.0 | 65.0 | 80.2 |
| | loading² | | | | | | | | |

| | | | | | | | | |
|---|---|---|---|---|---|---|---|---|
| Core flow rate | 450 | 300 | 300 | 300 | 400 | 150 | 150 | 150 |
| (mL/h) | | | | | | | | |
| Take-up rate | 50 | 15 | 15 | 25 | 20 | 10,20, | 10,20, | 10, 20 |
| (m/min) | | | | | | 30 | 30 | |
| Air gap (cm) | | | | | 5 | | | |
| Spinning Temperature | | | | | 25 | | | |
| (° C.) | | | | | | | | |
| Bath Temperature (° C.) | | | | | 25 | | | |

¹Some additives were used for successful fiber spinning. PVP and LiNO₃ act as a pore former in CA and PES fiber, respectively. LiCl contributes to dissolving cellulose in NMP.
²Ideal loading is the fraction of μPCM in the final (post drying) μPCM-polymer fiber with the assumption of no leaching of μPCM during the spinning process.

The μPCM-added polymer solutions were loaded into high-pressure syringe pumps (Teledyne Isco, 500D), and a 1/16″ Swagelok tube adapter was used in place of a custom co-axial spinneret because of concerns over clogging due to the size of μPCM particles. A dry jet wet-quench solution spinning process was performed at room temperature (about 25° C.). The spinning parameters are also summarized in Table 1 above. The as-spun fibers were soaked in DI water for three days with the DI water being replenished once a day to remove residual solvent, SDS, and water-soluble additive. Then, the fibers were dried in a fume hood overnight, and transferred to a vacuum oven at 60° C. the following night to remove any residual waters.

Scanning Electron Microscopy (SEM) images of the μPCM samples and μPCM-loaded polymer fibers were made using a Hitachi SEM SU-8010 instrument with a beam energy of 5 kV and an emission current of 10 μA. For cross-section observation, fiber samples were cryo-fractured in liquid nitrogen to get a clean cross-section. As-spun μPCM-cellulose fibers swollen by water were fractured first and then dried to prevent μPCMs from being ruptured at the cross-sectional area. For all SEM samples, a thin gold layer was applied using a Hummer Gold/Palladium sputterer.

Thermal response behaviors of μPCM samples and μPCM-loaded polymer fibers were measured using a Differential Scanning Calorimeter (Discovery DSC, TA Instruments) equipped with an electric cooling system. Amounts and rates of heat-releasing or heat-absorption during the phase change from liquid to solid or solid to liquid were measured. The temperature- and heat-sensing capabilities of the DSC were calibrated with indium. Approximately 5 mg of μPCM samples or μPCM-loaded polymer fiber fragments were loaded in the aluminum pan, and the aluminum lid to the pan was pressurized by a sealing press to facilitate a closed system. The heating and cooling system of DSC control the temperature from 0 to 40° C. or 40 to 0° C. with a constant heating or cooling rate of 1° C./min. The heating and cooling were repeated two times for each sample to check the reversible thermal response behavior.

Dynamic Mechanical Analysis (DMA) was performed on Q800 (TA Instruments) to investigate the mechanical stabilities of μPCM-loaded polymer fibers. The fibers were mounted in the sample clamp, and the tensile strength of the fibers was measured with a 0.01% strain displacement at room temperature.

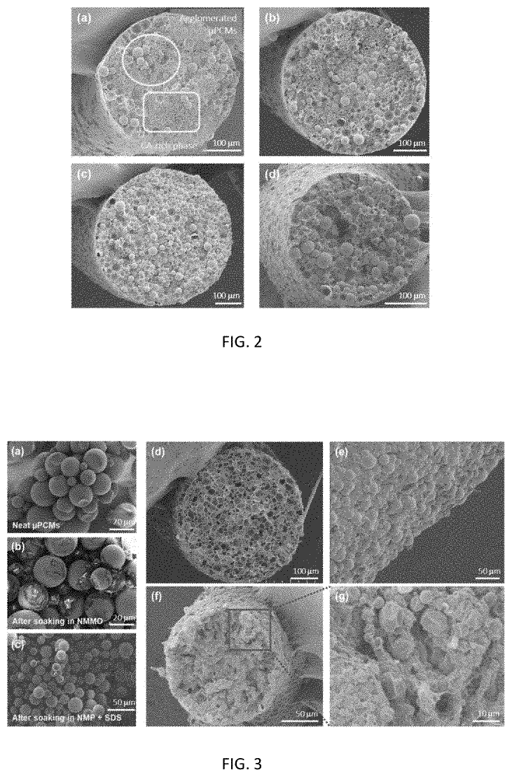

The preparation of polymer solution including some solid additives (e.g., metal-organic frameworks particles) required alternate stirring and/or sonication repetitively to achieve high dispersion of solid PCM particles in the polymer solution. In some examples, sodium dodecyl sulfate (SDS), an ionic surfactant having both hydrophobic and hydrophilic groups, was used to make the dispersed μPCM-polymer solution. SDS is removed during the spinning process or the solvent-exchange process in a DI water bath since the SDS is a water-soluble surfactant. As shown in FIG. 2(a), μPCM-CA fibers spun without SDS showed both CA-rich phases and some agglomerated μPCMs implying that the dispersion of μPCMs in the polymer solution cannot be maintained after the sonication. However, as shown in FIG. 2(b), the CA-rich phase or agglomerated μPCMs was rarely observed in μPCM-CA fibers spun with a small amount of SDS (less than 1 wt % in the dope). While not wanting to be bound by theory, it is believed that the μPCMs can be readily dispersed in the liquid mixture on a shear mixer for a relatively short time with SDS, which can be attached to the surface of μPCMs. After that, when the polymer is added, mixed, and dissolved in the liquid mixture increasing the dope's viscosity, the polymer and SDS solution can maintain the dispersion of μPCMs. This energy-efficient and straightforward procedure, which does not necessarily require sonication, enables the preparation of well-dispersed μPCM-polymer solution on a large scale for the practical applications.

μPCM-CA and μPCM-PES dope were prepared in the same way with a higher μPCM loading, and PVP and LiNO₃ were used as a pore-former and a macrovoid-suppressor for CA and PES fiber, respectively. To fabricate ‘blended’ μPCM fibers, three types of μPCM were loaded in the polymer dope. Because of the high initial loading of μPCM (>70 wt %), the polymer phase at the cross-sectional area of the fiber was not readily discernable as shown in FIGS. 2(c) and 2(d). However, spun fibers without any line breakage were obtained at the high PCM loading during the entire spinning process.

To spin μPCM-cellulose fibers, the well-known NMMO solvent system was tested, which is widely used in the industrial production process (known as the ‘Lyocell process’) of regenerated cellulose. The chemical stability of the μPCM in the spinning solvents before making a cellulose solution indicated that the structure of μPCM was deformed after the exposure to the mixture of NMMO and water at 80° C. as shown in FIG. 3(b). Since the NMMO solvent system was not suitable for the fabrication of μPCM-cellulose fibers, the chemical stability of the μPCM in NMP/LiCl/SDS solution system at 120° C. was examined, and indicated that μPCM could maintain its original spherical shape as shown in FIG. 3(a) after soaking in the solution system as shown in FIG. 3(c). The latent heat properties of the PCM were advantageously retained.

A μPCM-cellulose solution at 120° C. was prepared in the NMP/LiCl/SDS solution system and spun μPCM-cellulose fibers were obtained with the initial μPCM loading amount of around 73 wt %, similar to the μPCM-CA and μPCM-PES fibers (FIGS. 2(c) and 2(d)). Surprisingly, when we observed the cross-sectional area of μPCM-cellulose fibers as shown in FIG. 3(d), all μPCMs were ruptured although the μPCMs at the shell-side maintained their shape as shown in FIG. 3(e), which can be attributed to drying-induced volume shrinkage of the μPCM-cellulose fibers. To prevent μPCMs from being ruptured at the cross-sectional area, the μPCM-cellulose fibers soaked in water were fractured first at room temperature and then dried. Because of the low binding between μPCMs and the cellulose matrix in the swollen state, the μPCMs were not ruptured when the fibers were fractured at room temperature, but some μPCMs were observed to be deformed somewhat because of the shrinkage of neighboring cellulose matrix during the drying step as shown in FIGS. 3(f) and 3(g).

The aforementioned results support that μPCMs can be successfully dispersed and incorporated into various polymer fibers, and it was visually confirmed by SEM. The thermal properties of neat μPCMs and μPCMs in the fiber were explored using differential scanning calorimetry (DSC).

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A microencapsulated phase change material fiber composite comprising:
microencapsulated phase change material; and
a polymer, wherein the microencapsulated phase change material is greater than 50 percent by weight of the fiber.

2. The microencapsulated phase change material fiber of claim 1, wherein the microencapsulated phase change material is greater than 60 percent by weight of the fiber.

3. The microencapsulated phase change material fiber of claim 1, wherein the microencapsulated phase change material is greater than 70 percent by weight of the fiber.

4. The microencapsulated phase change material fiber of claim 1, wherein the polymer comprises cellulose, polyethersulfone, or cellulose acetate.

5. The microencapsulated phase change material fiber of claim 1, wherein the microencapsulated phase change material comprises a mixture of different phase change materials.

6. The microencapsulated phase change material fiber of claim 1, wherein the microencapsulated phase change material comprises phase change material having a melting point in a range of about 22° C. to about 40° C.

7. The microencapsulated phase change material fiber of claim 1, wherein the microencapsulated phase change material comprises phase change material having a latent heat of at least about 40 J/g.

8. A fabric comprising:
a plurality of fibers, wherein the fibers comprise microencapsulated phase change material; and
a polymer, wherein the microencapsulated phase change material is greater than 50 percent by weight of the fiber.

9. The fabric of claim 8, wherein the microencapsulated phase change material is greater than 60 percent by weight of the fiber.

10. The fabric of claim 8, wherein the microencapsulated phase change material is greater than 70 percent by weight of the fiber.

11. The fabric of claim 8, wherein the polymer comprises cellulose, polyethersulfone, or cellulose acetate.

12. The fabric of claim 8, wherein the microencapsulated phase change material comprises a mixture of different phase change materials.

13. The fabric of claim 8, wherein the microencapsulated phase change material comprises phase change material having a melting point in a range of about 22° C. to about 40° C.

14. The fabric of claim 8, wherein the microencapsulated phase change material comprises phase change material having a latent heat of at least about 40 J/g.

15. The fabric of claim 8, wherein the fabric is non-woven.

16. A mattress comprising:
at least one fabric layer in contact and/or in proximity to an end user, wherein the at least one fabric layer comprises a plurality of fibers, wherein the fibers comprise microencapsulated phase change material; and a polymer, wherein the microencapsulated phase change material is greater than 50 percent by weight of the fiber.

17. The mattress of claim 16, wherein the microencapsulated phase change material is greater than 60 percent by weight of the fiber.

18. The mattress of claim 16, wherein the microencapsulated phase change material is greater than 70 percent by weight of the fiber.

19. The mattress of claim 16, wherein the polymer comprises cellulose, polyethersulfone, or cellulose acetate.

20. The mattress of claim 16, wherein the microencapsulated phase change material comprises a mixture of different phase change materials.

21. The mattress of claim 16, wherein the microencapsulated phase change material comprises phase change material having a inciting point in a range of about 22° C. to about 40° C.

22. The mattress of claim 16, wherein the microencapsulated phase change material comprises phase change material having a latent heat of at least about 40 J/g.

23. The mattress of claim 16, wherein the at least one fabric layer is non-woven.

24. The mattress of claim 16, wherein the at least one fabric layer comprises a bedsheet, a pillowcase, a quilt layer, a comforter, and/or a topper layer.

25. A dry jet/wet spinning process of manufacturing a fiber comprising:
providing a spin dope, wherein the spin dope comprises microencapsulated phase change materials, a polymer, a water soluble surfactant, and a solvent, wherein the polymer is soluble in the solvent and the microencapsulated phase change material is uniformly dispersed in the spin dope without sonication,
pumping the spin dope into a multi-hole spinneret to extrude filaments therefrom;
feeding the filaments into a coagulation bath system to form microencapsulated phase change material fiber composites and removing residual solvent and water soluble surfactant, wherein the spinneret is spaced apart from the coagulation bath by an air gap; and
drawing the fiber, wherein the microencapsulated phase change material is greater than 50 percent by weight of the fiber.

26. The process of claim 25, wherein the microencapsulated phase change material is greater than 60 percent by weight of the fiber.

27. The process of claim 25, wherein the microencapsulated phase change material is greater than 70 percent by weight of the fiber.

28. The process of claim 25, wherein the polymer comprises cellulose, polyethersulfone, or cellulose acetate.

29. The process of claim 25, wherein the microencapsulated phase change material comprises a mixture of different phase change materials.

30. The process of claim 25, wherein the microencapsulated phase change material comprises phase change material having a melting point in a range of about 22° C. to about 40° C.

31. The process of claim 25, wherein the microencapsulated phase change material comprises phase change material having a latent heat of at least about 40 J/g.
